(19) United States
(12) Patent Application Publication
(10) Pub. No.: US 2009/0182103 A1
(43) Pub. Date: Jul. 16, 2009

(54) METHOD FOR POLYMERIZATION AND COPOLYMERIZATION OF OLEFIN

(75) Inventors: Ho-Sik Chang, Daejeon (KR); Chung-Byun Yang, Daejeon (KR)

Correspondence Address: BARLOW, JOSEPHS & HOLMES, LTD., 101 DYER STREET, 5TH FLOOR, PROVIDENCE, RI, 02903, US

(73) Assignee: SAMSUNG TOTAL PETROCHEMICALS, LTD., Chungcheongnam-do (KR)

(21) Appl. No.: 12/293,083

(22) PCT Filed: Mar. 26, 2007
(86) PCT No.: PCT/KR2007/001454

§ 371 Date: Dec. 31, 2008

(30) Foreign Application Priority Data
Apr. 19, 2006 (KR) 10-2006-0035249

(51) Int. Cl. C08F 4/52; C08F 4/50; C08F 4/58

(52) U.S. Cl. 526/124.7; 526/125.8; 526/125.3

(57) ABSTRACT

Disclosed is a method for polymerization and copolymerization of olefin characterized by polymerizing or copolymerizing olefins in the presence of: (A) a prepolymerized catalyst obtained by prepolymerizing olefins in the presence of (a) a solid complex titanium catalyst prepared by the following steps, (b) an aluminum alkyl and halogenated aluminum, and (c) an electron donor, wherein the steps comprises: (i) preparing a magnesium compound solution by dissolving a magnesium halide compound into an oxygen-containing solvent mixture of a cyclic ether and one or more alcohols; (ii) preparing a carrier by firstly reacting the resulted magnesium compound solution with a titanium halide compound at −10-30° C., elevating the temperature or aging the resulted product to obtain particles, and secondly reacting the resulted product with a titanium halide compound; (iii) preparing a titanium catalyst by reacting the obtained carrier with a titanium halide compound and an electron donor; and (iv) washing the resulted catalyst with a hydrocarbon solvent at 40-200° C.; (B) an organometallic compound from Group II or III of Periodic table of elements; and (C) an external electron donor. The method for polymerization and copolymerization of olefin can provide olefin polymers having high stereoregularity, enhanced polymerization activity and improved productivity in a polymerization process.

### TECHNICAL FIELD

The present invention relates to a method for polymerization and copolymerization of olefin, specifically to a method for polymerization and copolymerization of olefin using a prepolymerized catalyst obtained by prepolymerizing olefins with a solid complex titanium catalyst at low temperature under low pressure.

### BACKGROUND ART

Many catalysts for polymerization of olefin and polymerization methods using the same have been reported so far. However, there still have been needs for more efforts to: improve physical properties of the resulted polymers by using a catalyst invented to have more improved commercial qualities; thus raise productivity; or enhance the product quality, and many demands for improvement in the activity and stereoregularity of a catalyst itself.

Magnesium-containing and titanium-based catalysts for polymerization of olefin, and methods for producing such catalysts have been reported many. Particularly, methods for preparing a catalyst using a magnesium compound solution have been well known in the art, in order to adjust the shape, size or the like of the catalyst.

For example, there is a method for obtaining a magnesium solution by reacting a magnesium compound with an electron donor such as alcohols, amines, ethers, esters, carboxylic acids and the like, in the presence of a hydrocarbon solvent. Methods using alcohols are disclosed in U.S. Pat. Nos. 4,330,649 and 5,106,807, and Japanese laid-open patent publication Sho 58-83006. Further, methods for preparing a magnesium solution are also reported in U.S. Pat. Nos. 4,315,874, 4,399,054 and 4,071,674.

Tetrahydrofuran, that is a cyclic ether, has been variously utilized with a magnesium chloride compound, for example in U.S. Pat. No. 4,482,687, as an additive for a cocatalyst, for example in U.S. Pat. No. 4,158,642, as a solvent, for example in U.S. Pat. No. 4,477,639 and the like.

U.S. Pat. Nos. 4,347,158, 4,422,957, 4,425,257, 4,618,661 and 4,680,381 suggest methods for preparing a catalyst, in which a Lewis acid compound such as aluminum chloride is added to a supporter, magnesium chloride, and the mixture is ground to prepare a catalyst.

### DISCLOSURE OF INVENTION

### Technical Problem

Although the catalyst activity has been improved in above-mentioned patents, there still have been needs for further improvement regarding the catalyst morphology such as the shape, size, size distribution and stereoregularity of a catalyst.

As it has been described above, the aspects for improving the commercial value of a catalyst for polymerization of alpha-olefin are focused on: efforts to produce a catalyst having a high polymerization activity and stereoregularity so as to enhance the product quality; efforts to control the shape and the size of a catalyst so as to improve productivity; and efforts to improve the production yield and the activity of a catalyst in catalyst preparation so as to save the production cost. These efforts are strongly needed in the art, since they are important factors in catalyst economy.

### Technical Solution

The present invention has been designed to overcome the problems of prior arts. Accordingly, the object of the present invention is to provide a method for polymerization and copolymerization of olefin, which can provide high polymerization activity and a polymer of high stereoregularity.

The method for polymerization or copolymerization of olefin according to the present invention is characterized by polymerizing or copolymerizing olefin in the presence of:

(A) a prepolymerized catalyst obtained by prepolymerizing olefins in the presence of (a) a solid complex titanium catalyst prepared by the following steps, (b) an aluminum alkyl and halogenated aluminum, and (c) an electron donor,

wherein the steps comprises:

(i) preparing a magnesium compound solution by dissolving a magnesium halide compound into an oxygen-containing solvent mixture of a cyclic ether and one or more alcohols;

(ii) preparing a carrier by firstly reacting the resulted magnesium compound solution with a titanium halide compound at −10-30° C., elevating the temperature or aging the resulted product to obtain particles, and secondly reacting the resulted product with a titanium halide compound;

(iii) preparing a titanium catalyst by reacting the obtained carrier with a titanium halide compound and an electron donor; and

(iv) washing the resulted catalyst with a hydrocarbon solvent at 40-200° C.;

(B) an organometallic compound from Group II or III of Periodic table of elements; and

(C) an external electron donor.

In the preparation of (a) a solid complex titanium catalyst, examples of the magnesium halide compound used in the step (i) may include halogenated magnesium, alkylmagnesium halide, alkoxymagnesium halide and aryloxymagnesium halide. The magnesium halide compound may be used as a mixture of two or more species, or still may be effectively used in the form of a complex compound with other metal.

The cyclic ether used in the step (i) is preferably cyclic ethers having 3-6 membered ring or derivatives thereof, more preferably tetrahydrofuran and 2-methyl tetrahydrofuran, and most preferably tetrahydrofuran.

The alcohol compound used in the step (i) is preferably monovalent or polyvalent alcohols having C1-20, and more preferably alcohols having C2-12.

The amount of the oxygen-containing solvent mixture used in the step (i) is 1-15 moles, or preferably about 2-10 moles, per mole of magnesium atom in the magnesium halide compound. When the amount is less than 1 mole, the magnesium halide compound is hardly dissolved. However, when it is more than 15 moles, the amount of the magnesium halide compound added to obtain catalyst particles becomes too excessive, and particle control also becomes difficult.

The ratio of the cyclic ether and the alcohol which form an oxygen-containing solvent mixture used in the step (i), may be suitably adjusted, since the particle characteristics and the size of the resulted catalyst can be varied depending on the ratio, however preferred is 0.5-3.5 moles of alcohol per mole of cyclic ether.

The temperature during dissolution in the step (i) may vary depending on the kinds and the amount of the cyclic ether and the alcohol, but preferably in the range of 20-200° C., and more preferably about 50-150° C.

In the step (i), a hydrocarbon solvent can be additionally used as a diluting agent. The kinds of the hydrocarbon solvent include: for example, aliphatic hydrocarbons such as pentane, hexane, heptane, octane, decane and kerosene; alicyclic hydrocarbons such as cyclohexane and methylcyclohexane; aromatic hydrocarbon such as benzene, toluene, xylene and ethyl benzene; and halogenated hydrocarbons such as trichloroethylene, carbon tetrachloride and chlorobenzene.

In the preparation of (a) a solid complex titanium catalyst, the step (ii) comprises: firstly adding a titanium halide compound represented by the following general formula (I) to the magnesium compound solution obtained from the step (i) with the molar ratio of the oxygen-containing solvent mixture to the titanium halide compound being 1:3.0-10 at −10-30° C., in a way of being careful not to generate particles; precipitating particles by elevating the temperature of the resulted mixture or aging it; and secondly adding a titanium halide compound of the following general formula (I) for a further reaction so as to obtain solid particles being used as a carrier.

Ti(OR)ₐX₍₄₋ₐ₎ (I)

wherein, R is an alkyl group having C1-10; X is a halogen atom; and a is an integer of 0-3 which satisfies the atomic valence of the general formula.

In firstly adding the titanium halide compound to the magnesium compound solution in the step (ii), it is important to prevent particle precipitation from being occurred in terms of adjusting the shape of the resulted carrier, by adjusting conditions such as the temperature during the addition, the molar ratio of the oxygen-containing solvent mixture to the titanium halide compound and the like. Further, the second addition of the titanium halide compound, after the generation of carrier particles, makes possible to elevate the production yield in catalyst preparation.

The step (iii) in the preparation of (a) a solid complex titanium catalyst, is the step of reacting the carrier obtained from the step (ii) with a titanium halide compound and an electron donor so as to make the carrier supported to titanium. The step may be completed by single reaction, but the step is preferably done through twice or three times of repeated reactions.

In the step (iii), the carrier obtained from the step (ii) is preferably reacted with a titanium halide compound, and optionally together with an appropriate electron donor. After removing the mixture in liquid form, the residual slurry is, again reacted with a titanium compound and an electron donor, and then the solid part is separated and dried to obtain a catalyst.

As for the kinds of the electron donor used in the above step (iii), compounds containing oxygen, nitrogen or phosphorus may be mentioned. Particular examples of such compounds include organic acids, organic acid esters, alcohols, ethers, aldehydes, ketones, amines, amine oxides, amides, phosphate esters and the like. Among them, particularly preferred are benzoic acid alkyl esters such as ethylbenzoate, ethylbromobenzoate, butylbenzoate, isobutylbenzoate, hexylbenzoate and cyclohexylbenzoate, and derivatives thereof, and dialkylphthalates having C2-10 such as diisobutylphthalate, diethylphthalate, ethylbutylphthalate and dibutylphthalate, and derivatives thereof.

The step (iv) in the preparation of (a) a solid complex titanium catalyst, is the step of washing the catalyst prepared from the step (iii) with a hydrocarbon solvent at high temperature. Through this step, a catalyst with high stereoregularity is completed.

Examples of the hydrocarbon solvent used in the step (iv) include: aliphatic hydrocarbons such as pentane, hexane, heptane, octane, decane and kerosene; alicyclic hydrocarbons such as cyclohexane and methylcyclohexane; aromatic hydrocarbons such as benzene, toluene, xylene and ethylbenzene; and halogenated hydrocarbons such as trichloroethylene, carbon tetrachloride and chlorobenzene.

In order to further raise the stereoregularity of a solid complex titanium catalyst, the temperature during the washing step (iv) is preferably in the range of 40-200° C., and more preferably in the range of about 50-150° C.

The solid complex titanium catalyst prepared by the above steps (i)-(iv) is used in a prepolymerization process for preparing a prepolymerized catalyst used in the present invention.

The prepolymerization process is a process of prepolymerizing olefins in the presence of (a) the solid complex titanium catalyst prepared as the foregoing method, (b) an aluminum alkyl, and (c) an electron donor.

The reaction temperature of the prepolymerization process is preferably −50-50° C. When the reaction temperature is less than −50° C., the polymerization reaction is carried out too slow, and when it is more than 50° C., the polymerization reaction is so rapidly conducted that it is difficult to control the polymer shape.

In the foregoing reaction temperature range, olefin monomers are reacted to form polymers having high molecular weight on the surface of a solid complex titanium catalyst. As the result, the polymers having high molecular weight formed on the surface of a solid complex titanium catalyst will be 1-100 g per g of the solid complex titanium catalyst.

As for the olefin monomers used in the prepolymerization process, at least one selected from the group consisting of ethylene, propylene, 1-butene, 1-hexene and 1-octene is preferably used.

When carrying out the prepolymerization process in liquid phase, inert solvents such as hexane, heptane or kerosene may be used as a reaction medium, however olefin itself can be served as a reaction medium.

In liquid phase prepolymerization, the concentration of (a) the solid complex titanium catalyst in the prepolymerization reaction system is about 0.01—about 500 mmol, being calculated as titanium atom in 1 L solvent, and preferably about 1—about 50 mmol. When the concentration is less than 0.01 mmol, it is difficult to carry out polymerization in effective way, however, when it is more than 500 mmol, it causes a problem that the catalyst becomes over-activated during the polymerization reaction.

The aluminum alkyl in above (b) used in the prepolymerization system is preferably selected from trialkylaluminums and trialkenylaluminums, wherein examples of the trialkylaluminums may include triethyl aluminum or tributyl aluminum, and examples of the trialkenylaluminums may include triisoprenylaluminum.

The halogenated aluminum in above (b) used in the prepolymerization system is preferably selected from ethylaluminum sesquichloride, ethylaluminum dichloride, propylaluminum dichloride and butylaluminum dibromide.

The amount of (b) the aluminum alkyl and the halogenated aluminum used in the prepolymerization system is preferably selected from ethylaluminum sesquichloride, ethylaluminum dichloride, propylaluminum dichloride and butylaluminum dibromide.

Being used is about 1-100 moles and preferably about 2-50 moles, per mole of titanium atom in (a) the solid complex titanium catalyst. When the amount is less than 1 mole, it is difficult to carry out the polymerization reaction in effective way, however when it is more than 100 moles, it causes a problem that polymerization becomes over-activated at initial stage.

The ratio of using the aluminum alkyl and the halogenated aluminum is preferably 1-2 moles of halogenated aluminum per mole of aluminum alkyl.

The electron donor (c) in the prepolymerization system is preferably an organosilicon compound having an alkoxy group. Examples of the alkoxysilane compound include aromatic silanes such as diphenyldimethoxysilane, phenyltrimethoxysilane, phenylethyldimethoxysilane and phenylmethyldimethoxysilane, and aliphatic silanes such as isobutyltrimethoxysilane, diisobutyldimethoxysilane, diisopropyldimethoxysilane, di-t-butyldimethoxysilane, t-butyltrimethoxysilane, cyclohexylmethyldimethoxysilane, dicyclopentyldimethoxysilane, dicyclohexyldimethoxysilane, 2-norbornanetriethoxysilane, 2-norbornanemethyldimetoxysilane and vinyltriethoxysilane, and mixtures thereof. Among these silane compounds, more preferred are branched alkyldialkoxysilanes such as diisobutyldimethoxysilane and cycloalkyldialkoxysilanes such as dicyclopentyldimethoxysilane. The above-mentioned compounds may be used alone or as a mixture of two or more compounds.

The amount of (c) the electron donor being used is about 0.001-3 moles and preferably 0.1-1.0 mole, per mole of titanium atom in (a) the solid complex titanium catalyst. When the amount of use is less than 0.001 mole, the effect of using an electron donor is hardly obtained, however when it is more than 3 moles, it leads adverse effects owing to the excessive use thereof.

The prepolymerized catalyst produced by the steps as described above is advantageously used in polymerizing olefins such as ethylene, propylene, 1-butene, 3-methyl-1-butene, 4-methyl-1-pentene, vinylcycloalkane or cycloalkene. Particularly, the prepolymerized catalyst is advantageously used in: polymerization of α-olefins having 3 or more of carbon atoms; copolymerization of said α-olefins; copolymerization of those olefins which have less than 20 mol % of ethylene; and copolymerization of said those which comprise polyunsaturated compounds such as conjugated or unconjugated dienes.

The method for polymerization of olefin according to the present invention is a process of polymerizing or copolymerizing olefin in the presence of (A) a prepolymerized catalyst, which is prepared and encapsulated with polymers having high molecular weight, by the above-described steps. (B) an organometallic compound from Group II or III of Periodic table of elements, and (C) an external electron donor.

Examples of (B) the organometallic compound used as a cocatalyst in the polymerization process include, for example: trialkylaluminums such as triethylaluminum and tributylaluminum; trialkenylaluminums such as triisoprenylaluminum; dialkylaluminum alkoxides such as partially alkoxylated alkyl aluminums, for instance, diethylaluminum ethoxide and dibutylaluminum butoxide; alkylaluminum sesquialkoxide such as ethylaluminum sesquiethoxide and butylaluminum sesquiethoxide; alkylaluminum dihalides such as ethylaluminum dichloride, propylaluminum dichloride and butylaluminum dibromide; partially halogenated aluminum; dialkylaluminum hydrides such as diethylaluminum hydride or dibutylaluminum hydride; partially alkoxylated and halogenated alkylaluminums such as ethylaluminum ethoxychloride, butylaluminum butoxychloride and ethylaluminum ethoxybromide, and the like.

As for (C) the external electron donor used in the polymerization process, external donor materials which are generally used in conventional polymerization of olefin may be used. These external electron donor are mainly used for optimizing the activity and stereoregularity of a catalyst in polymerization of olefin.

Examples of the external electron donor which can be used in the present invention include organic compounds comprising hetero atoms such as oxygen, silicon, nitrogen, sulfur, phosphorous and the like, and mixtures thereof, for example, organic acids, organic acid anhydrides, organic acid esters, alcohols, ethers, aldehydes, ketones, silanes, amines, amine oxides, amides, diols and phosphate esters. Preferred external donors are organosilicon compounds having an alkoxy group, that is alkoxy silane compounds, which includes for example, aromatic silanes such as diphenyldimethoxysilane, phenyltrimethoxysilane, phenylethyldimethoxysilane and phenylmethyldimethoxysilane, aliphatic silanes such as isobutyltrimethoxysilane, diisobutyldimethoxysilane, diisopropyldimethoxysilane, di-t-butyldimethoxysilane, t-butyltrimethoxysilane, cyclohexylmethyldimethoxysilane, dicyclopentyldimethoxysilane, dicyclohexyldimethoxysilane, 2-norbornanetriethoxysilane, 2-norbornanedimethoxysilane and vinyltriethoxysilane, and mixtures thereof. Among these silane compounds, more preferred are branched alkyldialkoxysilanes such as diisobutyldimethoxysilane and cycloalkyldialkoxysilanes such as dicyclopentyldimethoxysilane. The above-mentioned compounds may be used alone or as a mixture of two or more compounds.

When carrying out the method of polymerization according to the present invention in liquid phase, inert solvents such as hexane, heptane or kerosene may be used as a reaction medium, however olefin itself can be served as a reaction medium. In liquid phase polymerization, the preferred concentration of (A) the prepolymerized catalyst in the polymerization reaction system is about 0.001—about 5 mmol, being calculated as titanium atom in 1 L solvent, and preferably about 0.001—about 0.5 mmol. In gas phase polymerization, the amount of (A) the prepolymerized catalyst is about 0.001—about 5 mmol, preferably about 0.001—about 1.0 mmol and more preferably 0.01—about 0.5 mmol, being calculated as titanium atom in 1 L of polymerization system. Further, the ratio of the organometallic atom in (B) the organometallic compound is about 1-2,000 moles and preferably about 5-500 moles per mole of titanium atom in (A) the prepolymerized catalyst, and the ratio of (C) the external electron donor, when being calculated as hetero atom in the external electron donor, is about 0.001-10 moles, preferably about 0.01-2 moles and more preferably 0.05-1 mole, per mole of organometallic atom in the organometallic compound.

The polymerization and copolymerization of olefin reaction in the presence of the catalyst system according to the present invention, is carried out as same as polymerization of olefin using a conventional Ziegler-type catalyst.

Explaining the reaction conditions with more details, the polymerization of olefin reaction is substantially conducted in the absence of oxygen and water, in the temperature range of about 20-200° C. and preferably about 50-180° C., under the pressure of about 1-100 atm and preferably about 2-50 atm.

The polymerization reaction can be carried out through a batch type or a semi-batch type process, or a continuous type process. It is also possible to carry out the polymerization reaction through two or more steps which are carried out under different reaction conditions.

### MODE FOR INVENTION

The present invention can be further understood by the following examples, which are provided to illustrate the present invention, however by no means limiting the scope to be protected in the present invention.

### EXAMPLES

### Example 1

### Preparation of a Prepolymerized Catalyst (A)

Step 1: Preparation of a Magnesium Compound Solution

To a 500 L reactor equipped with a mechanical stirrer of which atmosphere was substituted with nitrogen, 15 kg of MgCl₂, 225 kg of toluene, 17 kg of tetrahydrofuran and 31 kg of butanol were added. The mixture was heated to 110° C. with stirring at 70 rpm, and maintained at the temperature for 3 hours to obtain a homogeneous solution.

Step 2 : Preparation of a Carrier

The solution obtained from the above step 1 was cooled to 17° C. and 32 kg of TiCl₄ was added thereto. The temperature of the reactor was elevated to 60° C. over 1 hour. When the temperature reached to 60° C., 13 kg of TiCl₄ was added to the reactor over 40 minutes and allowed it for reaction for further 30 minutes. After the reaction, it was allowed to stand for 30 minutes to settle the resulted carriers, and the upper part of the solution was removed. To the residual slurry in the reactor, 90 kg of toluene was added, and the mixture was washed by repeating the series of steps of stirring, standing and removal of the supernatant, three times.

Step 3: Preparation of a Solid Complex Titanium Catalyst

To the carrier prepared from the above step 2, 80 kg of toluene and 90 kg of TiCl₄ were added with stirring at the speed of 60 rpm. The reactor temperature was elevated to 110° C., over 1 hour, and the mixture was aged for 1 hour and allowed to stand for 15 minutes so as to settle precipitates, and the resulted supernatant was separated. To the remained slurry, 87 kg of toluene, 52 kg of TiCl₄ and 4.2 kg of diisobutylphthalate were added, and the temperature was elevated to 120° C. and maintained 1 hour for further reaction. After the reaction, it was allowed to stand for 30 minutes, and the supernatant was removed. To the reactor, 80 kg of toluene and 76 kg of TiCl₄ were added, and the mixture was reacted at 100° C. for 30 minutes. After the reaction, it was allowed to stand for 30 minutes, and the supernatant was removed. To the residual slurry, 65 kg of hexane was added, and the temperature of the reactor was raised to 60° C. and maintained for 30 minutes while stirring. After halting the stirring, the mixture was allowed to stand for 30 minutes and the supernatant was removed. The residual catalyst slurry was washed by adding hexane thereto, and this washing process was repeated 6 times, thereby obtaining the final solid complex titanium catalyst. The Ti content of the resulted catalyst was 2.8 wt %.

Step 4: Prepolymerization

A 0.5 L high pressure reactor was cleansed with propylene and maintained at 15° C. To the reactor, 4 g of the catalyst obtained from above step 3, 300 □ of hexane, 5 mmol of triethylaluminum, 5 mmol of ethylaluminum dichloride and 0.5 mmol of cyclohexylmethyldimethoxysilane were added in this order, and the mixture was stirred for 30 minutes. Prepolymerization was carried out at 15° C. for 3 hours, while flowing propylene at the rate of 80 ml/minute. In the prepolymerized catalyst resulted therefrom, the amount of polymers having high molecular weight formed around the catalyst was 6.7 g per g of catalyst.

Polymerization

Polymerization of propylene was carried out in order to estimate the performance of the resulted prepolymerized catalyst. The prepared prepolymerized catalyst was placed in a high pressure bombe, with the amount of 10 mg, based on the solid complex titanium catalyst. The bombe was mounted to a 2 L high pressure polymerization reactor, and the reactor was purged with nitrogen for about 1 hour so as to form dry nitrogen atmosphere inside the reactor. Thereto, triethylaluminum (Al/Ti molar ratio=450) and dicyclohexyldimethoxysilane (Si/Al molar ratio=0.1) as an external donor were added, and the reactor was tightly closed. After feeding 1000 ml of hydrogen, 1200 ml of liquid propylene was fed through a syringe pump, and the temperature of the reactor was raised to 70° C. over 20 minutes. The prepolymerized catalyst was added to the reactor to carry out polymerization for 1 hour. After 1 hour, unreacted propylene was vented out to the air, and the temperature of the reactor was lowered to room temperature. The resulted polymer was dried in a vacuum oven at 50° C. and then weighed. With the resulted polymer, assays regarding xylene solubles and II (NMR pentad) were conducted, and the results were shown in Table 1. The xylene soluble assay is one of the methods for determining the isotactic index of polymers, wherein a certain amount of polymer sample is added to a xylene solution and completely dissolved thereinto at high temperature not less than 110° C., and the resulted solution is cooled to room temperature and filtered. The precipitated materials collected by filtering is separated and measured for the content of xylene solubles.

### Example 2

Preparation of a prepolymerized catalyst and polymerization were carried out as same as the method disclosed in Example 1, except that 10 mmol of triethylaluminum and 10 mmol of ethylaluminum dichloride were used for preparing the prepolymerized catalyst, in the step 4 of the prepolymerized catalyst preparation method. The results were shown in Table 1.

### Example 3

Preparation of a prepolymerized catalyst and polymerization were carried out as same as the method disclosed in Example 1, except that 15 mmol of triethylaluminum and 15 mmol of ethylaluminum dichloride were used for preparing the prepolymerized catalyst, in the step 4 of the prepolymerized catalyst preparation method. The results were shown in Table 1.

### Example 4

Preparation of a prepolymerized catalyst and polymerization were carried out as same as the method disclosed in Example 1, except that 5 mmol of triethylaluminum and 10 mmol of ethylaluminum dichloride were used for preparing the prepolymerized catalyst, in the step 4 of the prepolymerized catalyst preparation method. The results were shown in Table 1.

### Example 5

Preparation of a prepolymerized catalyst and polymerization were carried out as same as the method disclosed in Example 1, except that 5 mmol of triethylaluminum and 10 mmol of ethylaluminum sesquichloride were used for preparing the prepolymerized catalyst, in the step 4 of the prepolymerized catalyst preparation method. The results were shown in Table 1.

### Comparative Example 1

Preparation of a prepolymerized catalyst and polymerization were carried out as same as the method disclosed in Example 1, except that 15 mmol of triethylaluminum was used for preparing the prepolymerized catalyst, in the step 4 of the prepolymerized catalyst preparation method. The results were shown in Table 1.

### Comparative Example 2

Preparation of a prepolymerized catalyst and polymerization were carried out as same as the method disclosed in Example 1, except that 15 mmol of triisobutylaluminum was used for preparing the prepolymerized catalyst, in the step 4 of the prepolymerized catalyst preparation method. The results were shown in Table 1.

### [Table 1]

### [Table]

TABLE 1

| | Polymerization | Xylene solubles | II([mmmm] NMR |
|---|---|---|---|
| | activity (kgPP/gCat) | (%) | pentad, mol %) |
| Ex. 1 | 35 | 1.7 | 95.9 |
| Ex. 2 | 37 | 1.8 | 95.8 |
| Ex. 3 | 34 | 1.8 | 95.6 |
| Ex. 4 | 36 | 1.9 | 95.5 |
| Ex. 5 | 36 | 1.9 | 95.9 |
| Com. Ex. 1 | 28 | 1.9 | 95.8 |
| Com. Ex. 2 | 30 | 2.4 | 94.7 |

As it can be seen from the above table 1, the examples according to the polymerization and copolymerization of olefin of the present invention exhibit the reduced amount of xylene solubles in the prepared polymers and improved stereoregularity and polymerization activity, as compared to the comparative examples.

### INDUSTRIAL APPLICABILITY

The method for polymerization and copolymerization of olefin according to the present invention provides high stereoregularity in the resulted polymers, and improved polymerization activity, thereby improving productivity of the polymerization process.

1. A method for polymerization or copolymerization of olefin which polymerizes or copolymerizes olefins in the presence of (A), (B) and (C):
(A) a prepolymerized catalyst obtained by prepolymerizing olefins in the presence of (a) a solid complex titanium catalyst prepared by the following steps, (b) an aluminum alkyl and a halogenated aluminum, and (c) an electron donor, wherein the steps comprise:
(i) preparing a magnesium compound solution by dissolving a magnesium halide compound into an oxygen-containing solvent mixture of a cyclic ether and one or more alcohols;
(ii) preparing a carrier by firstly reacting the resulted magnesium compound solution with a titanium halide compound at −10-30° C. elevating the temperature or aging the resulted product to obtain particles, and secondly reacting the resulted product with a titanium halide compound;
(iii) preparing a titanium catalyst by reacting the obtained carrier with a titanium halide compound and an electron donor; and
(iv) washing the resulted catalyst with a hydrocarbon solvent at 40-200° C.;
(B) an organometallic compound from Group II or III of Periodic table of elements; and
(C) an external electron donor.

2. The method for polymerization or copolymerization of olefin according to claim 1, wherein the temperature for prepolymerization is −50-50° C.

3. The method for polymerization or copolymerization of olefin according to claim 1, wherein the olefin is at least one selected from the group consisting of ethylene, propylene, 1-butene, 1-hexene and 1-octene.

4. The method for polymerization or copolymerization of olefin according to claim 1, wherein the concentration of (a) the solid complex titanium catalyst in 1 L of solvent used in the prepolymerization system is 0.01-500 mmol, being calculated as titanium atom.

5. The method for polymerization or copolymerization of olefin according to claim 1, wherein (b) the aluminum alkyl is selected from trialkylaluminum and trialkenylaluminum.

6. The method for polymerization or copolymerization of olefin according to claim 1, wherein (b) the halogenated aluminum is selected from ethylaluminum sesquichloride, ethylaluminum dichloride, propylaluminum dichloride and butylaluminum dibromide.

7. The method for polymerization or copolymerization of olefin according to claim 1, wherein the amount of (b) the aluminum alkyl and the halogenated aluminum being used is 1-100 mole per mole of titanium atom in (a) the solid complex titanium catalyst.

8. The method for polymerization or copolymerization of olefin according to claim 1, wherein (c) the electron donor is an alkoxysilane compound.

9. The method for polymerization or copolymerization of olefin according to claim 8, wherein the alkoxysilane compound is selected from the group consisting of diphenyldimethoxysilane, phenyltrimethoxysilane, phenylethyldimethoxysilane, phenylmethyldimethoxysilane, isobutyltrimethoxysilane, diisobutyldimethoxysilane, diisopropyldimethoxysilane, di-t-butyldimethoxysilane, t-butyltrimethoxysilane, cyclohexylmethyldimethoxysilane, dicyclopentyldimethoxysilane, dicyclohexyldimethoxysilane, 2-norbornanetriethoxysilane, 2-norbornanemethyldimetoxysilane and vinyltriethoxysilane.

10. The method for polymerization or copolymerization of olefin according to claim 1, wherein the amount of (c) the electron donor being used is 0.001-3 moles per mole of titanium atom in (a) the solid complex titanium catalyst.
